(19) United States
(12) Patent Application Publication
(10) Pub. No.: US 2016/0189439 A1
(43) Pub. Date: Jun. 30, 2016

(54) TRI-SYSTEM SMARTPHONE MOBILE APPLICATION FOR OUTDOOR MOTOR SPORTS

(71) Applicant: VETCO, INC., Poway, CA (US)

(72) Inventors: Gerald A. Vetterick, Poway, CA (US); John H. Vetterick, Poway, CA (US)

(73) Assignee: VETCO, INC., Poway, CA (US)

(21) Appl. No.: 14/979,474

(22) Filed: Dec. 27, 2015

Related U.S. Application Data
(60) Provisional application No. 62/096,851, filed on Dec. 24, 2014.

(51) Int. Cl. G07C 5/00; G06Q 50/00; G01S 19/42; G06Q 30/02; G07C 5/02; G01C 21/36

(52) U.S. Cl. CPC G07C 5/006; G07C 5/02; G01C 21/3679; G01S 19/42; G01C 21/3697; G06Q 30/0259; G06Q 30/0267; G06Q 50/01; G06Q 30/0261

(57) ABSTRACT

A Tri-system Mobile Smartphone Application is provided with three major sub-system components: motor usage/monitoring (GPS based), vendor/marketing/location and social media/networking, designed to be used on a smartphone while engaging in outdoor motor sports. The vendor/marketing/location and social media/networking sub-systems are combined with methods for monitoring marine vessel movement in water for the purpose of monitoring mechanical usage, generating usage logs to recommend scheduled maintenance. Vessel origin position is monitored by recording geo-position information. When wireless device is within proximity of vessel, an installed application will monitor vessel position on water utilizing internet based map sets or stored maps. When a referenced device is introduced within a predetermined proximity, equivalent to GPS, timers are enabled and wait for coordinate movement consistent with vessel movement and monitoring begins. The primary purpose of monitoring is to recommend marine service based upon interval or usage time in motor operating hours.

### FIELD OF THE INVENTION

This invention describes a new Tri-system Mobile Smartphone Application (Mobile App) for use in outdoor motor sports such as boating, snowmobiling and off-reading with all-terrain vehicles (ATV's), motorcycles and the like. More particularly, the present invention provides a Tri-system Mobile App with three sub-systems dealing with motor usage/motor monitoring through a global positioning satellite (GPS) application sub-system, a marketing/vendor application sub-system, and a social media/networking application sub-system, all controlled by an individual with a smartphone by the means of a satellite or cell phone tower and Internet connection.

### BACKGROUND OF THE INVENTION

With the exception of luxury yachts, most boats haven't fundamentally changed for many years, but often, ownership does. Those new to boating can quickly lose their infatuation if they have a series of bad experiences. Most seek out solutions on their own and feel isolated, often hoping that they can find someone friendly and experienced that might assist them. The Tri-system Mobile App provides the software system that has been specifically configured to address these issues and make owners of recreational vehicles, especially boaters feel connected to their boat, their destinations, other boaters and vendors they may want to patronize. Recreational boaters have a greater need for the connections available with the Tri-system Mobile App, because of their relative inaccessibility when they are out on the water.

All vessel and recreational vehicle owners must maintain their units in order for them to function, safely and properly. Lapsed maintenance is a global problem and ignoring or being unaware of maintenance milestones is the predominant reason for breakdowns. This system solves that issue by integrating the how usage data with standard maintenance guidelines. When a usage milestone is reached, the system prompts the owner on his or her wireless device that recommended maintenance is due in the designated areas, it then uses the current global positioning satellite system (GPS) coordinates to deliver list views of the nearest locations available where such service can be provided.

Numerous innovations for the Tri-system Mobile App have been provided in the prior art that are described as follows. Even though these innovations may be suitable for the specific individual purposes to which they address, they differ from the present design as hereinafter contrasted. The following is a summary of those prior art patents most relevant to this application at hand, as well as a description outlining the difference between the features of the Tri-system Mobile App and the prior art.

U.S. Pat. No. 6,836,539 of Hironori Katou et al. describes an operating condition of an outboard motor that is detected by an ECU, and then, is transmitted to a remote monitoring apparatus using a mobile phone. The condition data transmission is made by only access from the outboard motor side, therefore, security can be secured. When confirming a failure based on the condition data, the remote monitoring apparatus decides the cause of failure by troubleshooting, and then, give information about measures to a boat equipped with the outboard motor. Troubleshooting is carried out by acquiring a program from a server of maker, and the cause of failure is transmitted to the server so as to be stored as user Information. The remote monitoring apparatus orders necessary maintenance parts so as to improve quickness of maintenance.

This patent describes an operating condition of an outboard motor that is detected by an ECU, and then, is transmitted to a remote monitoring apparatus using a mobile phone. The condition data transmission is made by only access from die outboard motor side, therefore, security can be secured. The Tri-system Mobile App does not require additional electronics to be purchased or installed on the motor and offers a wide range of capabilities with a system that enables the incorporation of geo-postioning, record the movement of a vessel, enables vendors to charge for products or services via the Wi-Fi enabled mobile device, track and maintain records on services and sales and have a direct wireless connection with other owners of similar recreational vehicles for assistance or social interaction.

U.S. Pat. No. 8,676,402 of Stephen Foster describes an electric sentry-system that provides utilities for the welfare of a docked boat. The sentry system serves as boat and lift control, and security, system that has a wireless interface for two-way communications with a mobile wireless device. The system is configured to receive commands sent from the mobile wireless device. The system is also configured to independently monitor conditions involving the boat, the lift, or the premises surrounding the docked boat slip, and provide notifications to the boat owner/relevant user upon the occurrence of certain report-worthy events. This includes having the system monitoring online sources for extreme weather and/or other climatic data.

This patent describes an electric sentry system that provides utilities for the welfare of a docked boat with a sentry system which serves as a boat and lift control, and security, system that has a wireless interface for two-way communications with a mobile wireless device. It does not have the capabilities of the Tri-system Mobile App with three major components: motor usage/monitoring (GPS based), vendor/marketing/location and social media/networking, all controlled by an individual with a smart phone by the means of a satellite or cellphone tower connection. The Tri-system Mobile App will be used Tor monitoring boats and other vessels, snowmobiles, ATV's, motorcycles and other off-road recreational vehicles.

While the prior patents have been successful to a certain extent, it is nonetheless clear that substantial room exists for affecting an advance in the art, which overcomes these shortcomings in a practical and efficient manner.

In this respect, before explaining at least one embodiment of the Tri-system Mobile App in detail it is to be understood that the design is not limited in its application to the details of construction and to the arrangement, of the components set forth in the following description or illustrated in the drawings. The Tri-system Mobile App is capable of other embodiments and of being practiced and carried out in various ways. In addition, it is to be understood that the phraseology and terminology employed herein are for the purpose of description and should not he regarded as limiting. As such, those skilled in the art will appreciate that the conception, upon which this disclosure is based, may readily be utilized as a basis for designing of other methods and systems for carrying out the several purposes of the present design. It is important, therefore, that the claims be regarded as including such equivalent construction insofar as they do not depart from the spirit and scope of the present application.

### SUMMARY OF THE INVENTION

The principle advantage of the Tri-system Mobile App provides a direct wireless connection with the needs and requirements of the owners of boats, vessels and other off-road motor sports recreational vehicles, such as motorcycles, snowmobiles and all-terrain vehicles (ATVs), to be known and referred to hereinafter by its trademark name BOAT VIBES™.

Another advantage is the Tri-system Mobile App provides a direct, wireless connection for acquiring the location of vendors, maintenance service establishments, fuel docks and fuel prices, as well as enabling those vendors to market their goods and services.

Another advantage of the Tri-system Mobile App is to create a permanent, wireless device accessible and updatable log, of all maintenance performed on the unit, including service records, and time and type of service performed, as well as alerting the user when service is due based upon motor maintenance schedules.

Another advantage is the Tri-system Mobile App provides a direct wireless social networking connection with other owners of similar boats, vessels, snowmobiles, ATV's, motorcycles and other off-road recreational vehicles for assistance or social interaction.

Another advantage is the Tri-system Mobile App provides a direct wireless connection for other personal needs such as shopping and restaurants and fishing conditions, as well as reviews others engaging in such activities locally or remotely.

Another advantage with the Tri-system Mobile App is that additional electronics do not need to be purchased, installed and maintained on the actual motor itself.

Another advantage is that registered vendors can invoice any services rendered directly to the user, thus eliminating payment issues while creating a service or visit record for the vendor or future vendors, and the user.

Another advantage of the Tri-system Mobile App is that the app menu selections, when searching for vendors, may be voice activated as well as typed in for input.

Another advantage of the Tri-system Mobile App is that updates from both users and vendors can be input through a conventional website.

The patent and claims of the Tri-system Mobile App described herein relates to a system that enables the incorporation of geo-positioning associated with an on water location to record the movement of a vessel or vehicle from one location to another. The system is part of a computer program that is downloaded onto the wireless device such as a smartphone or computer used by the vessel or vehicle owner. The system is activated by consistent linear movement greater than GPS introduced fault, radius on vessel or vehicle. In the instance of vessel tracking, mechanisms would not be set to ready state until it had been detected to be on water and within home port when beginning a new trip. Upon termination of movement and shutting off of the engine, the monitoring function is deactivated. It can also be paused by the user if he or she is simply running accessories on the unit and not using the engine. This hour meter usage is thus accomplished without the need for any installation of equipment.

The Tri-system Mobile App is a multi-functional provider of data, contacts, locations and feedback designed to provide to a person on their smartphone immediate responses to boaters whether they are on the water, towing their boat, at a service facility, looking for a restaurant, socializing with other boaters, or deciding about the future of their boat.

The Tri-system Mobile App provides methods for monitoring engine performance based on a comprehensive programming system utilizing on water GPS based motion Sensing, Derivative features provide for the use of core information provided by users and vendors registered within the system to engage in the exchange of mechanical, logistical and social services and communication on a global basis. This invention uses wireless technology to bring the complete spectrum of boating knowledge to boaters by providing extraordinary accessibility to those sources that are most important to safe and enjoyable boating, whether those sources are mechanical or service related, logistical, social, environmental or atmospheric.

This system solves that issue by integrating the hour usage data with standard maintenance guidelines. When a usage milestone is reached, the system prompts the owner on his or her wireless device that recommended maintenance is due in the designated areas. It then uses the current GPS coordinates to deliver list views of the nearest locations available where such service can be provided.

The Tri-system Mobile App has been designed to create a permanent, wireless device with an updatable log of all maintenance performed on the unit. The vessel or vehicle owner will input the basic data of his or her vessel into the appropriate registration form on this app. This data will include the vehicle make, year, model and identification number, the engine make, model, engine number and horsepower. The owner may also add any other service data that be wants and also the current hour meter reading if it is available. This record can then be accessed by vendors who register with the system and who are contacted by the owner. This greatly accelerates the accuracy and turnaround time on any service work performed. Much like a person's medical history, it is immediately available to the owner and to the vendor being contacted, which is important for emergency and offsite, as well as, routine service. A benefit of this, service record stored on the app's server is that it can travel with the boat or vehicle regardless of the owner. This will facilitate sale and service of the boat or vehicle in new locations.

It is a further objective of the Tri-system Mobile App is to provide logistical information to the vessel or vehicle user based upon his or her destination or current on water GPS coordinates. This information will he selected for view from subject matter displayed on a menu and further information will be available upon the user tapping a pin on the wireless screen.

It is an additional feature of the Tri-system Mobile App that the user will be able to identify and communicate with other users of the invention, based upon their on water GPS coordinates. This will allow the sharing of information, be it social, mechanical, logistical, atmospheric or environmental and the potential rendering of assistance to other users.

Still another function of the Tri-system Mobile App is to allow the user, based on the data in his or her service record, to contact other users about the possibility of buying, swapping or renting their respective vessels or vehicles or ordering a new unit direct from the manufacturer. The app user would post his or her request for a specific period of time on a form within the app, subject to legal restrictions acknowledged by the user.

The Tri-system Mobile App enables vendors to charge for products or services via a Wi-Fi enabled mobile device, track and maintain records on services and sales. A cache of data, store size limited records will be maintained on the device based upon a date/time criteria, with newest records being stored locally and older records stored on a centralized network server. Customers will be connected to a vendor(s) via the boat vibes application.

The foregoing has outlined rather broadly the more pertinent and important features of the present Tri-system Mobile App in order that the detailed description of the application that follows may be better understood so that the present contribution to the art may be more fully appreciated. Additional features of the design will be described hereinafter which, form the subject of the claims of this disclosure. It should be appreciated by those skilled in the art that the conception and the disclosed specific embodiment may be readily utilized as a basis for modifying or designing other methods for carrying out the same purposes of the present design. It should also be realized by those skilled in the art that such equivalent methods do not depart from the spirit and scope of this application as set forth in the appended claims.

### BRIEF DESCRIPTION OF THE DRAWINGS

The accompanying drawings, which are incorporated in and form a part of this specification, illustrate embodiments of the Tri-system Mobile App and together with the description, serve to explain the principles of this application.

FIG. 1 depicts a diagram of the smart phone BOAT VIBES™ Tri-system Mobile App.

FIG. 2 depicts a diagram of the three BOAT VIBES™ mobile smart phone App sub-systems.

FIG. 3 depicts a diagram of the steps taken by the BOAT VIBES™ mobile application, and the communications hardware network which facilitates the mobile app.

FIG. 4 depicts a diagram of the BOAT VIBES™ vessel position activation and monitoring process.

FIG. 5 depicts a diagram of the BOAT VIBES™ GPS signal present handling.

FIG. 6 depicts TABLE 1, which illustrates a tabular example of a BOAT VIBES™ boat or vessel motor or power plant maintenance action chart.

FIG. 7 depicts a diagram of the BOAT VIBES™ vendor application sub-system detail.

FIG. 8 depicts an illustration of two smartphones running the BOAT VIBES™ mobile application.

FIG. 9 depicts a diagram of the BOAT VIBES™ vendor tools flow.

FIG. 10 depicts a diagram of the BOAT VIBES™ visual flow.

FIG. 11 depicts a diagram of the BOAT VIBES™ networking visual flow.

FIG. 12 depicts a diagram of the BOAT VIBES™ social networking flow.

FIG. 13 depicts a diagram of the BOAT VIBES™ performed service flow.

FIG. 14 depicts a diagram of the BOAT VIBES™ service interval flow.

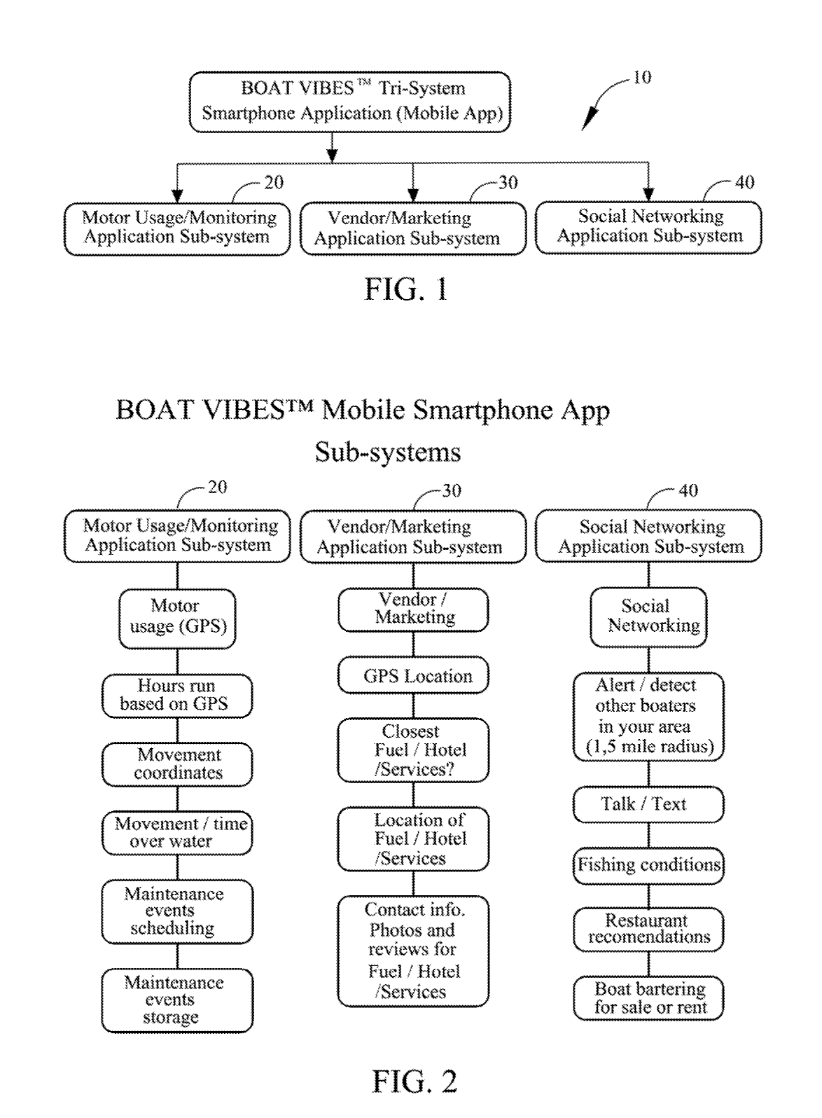

For a fuller understanding of the nature and advantages of the Tri-system Mobile App, reference should be had to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

Referring now to the drawings, wherein similar parts of the BOAT VIBES™ Tri-system Mobile App 10 are identified by like reference numerals with motor usage/monitoring application sub-system 20, vendor/marketing application sub-system 30 and social media/networking application sub-system 40.

FIG. 2 depicts a diagram of the BOAT VIBES™ mobile smart phone App sub-systems that will be comprised of the motor usage application sub-system 20 with examples being motor usage (GPS), hours run based on (GPS), movement coordinates, movement/time over water, maintenance events scheduling and maintenance events storage. The vendor/marketing application sub-system 30 could be comprised of the vendor/marketing, GPS location, closest fuel/hotel/services, and location of fuel/service, contact information/photos and reviews for fuel/hotel/services. The social networking application sub-system 40 be comprised of the social networking, alert/detect other boaters in your area (1.5 Mile radius), talk/text, fishing conditions, restaurant recommendations/locations, and boat bartering for sale, trade and rent.

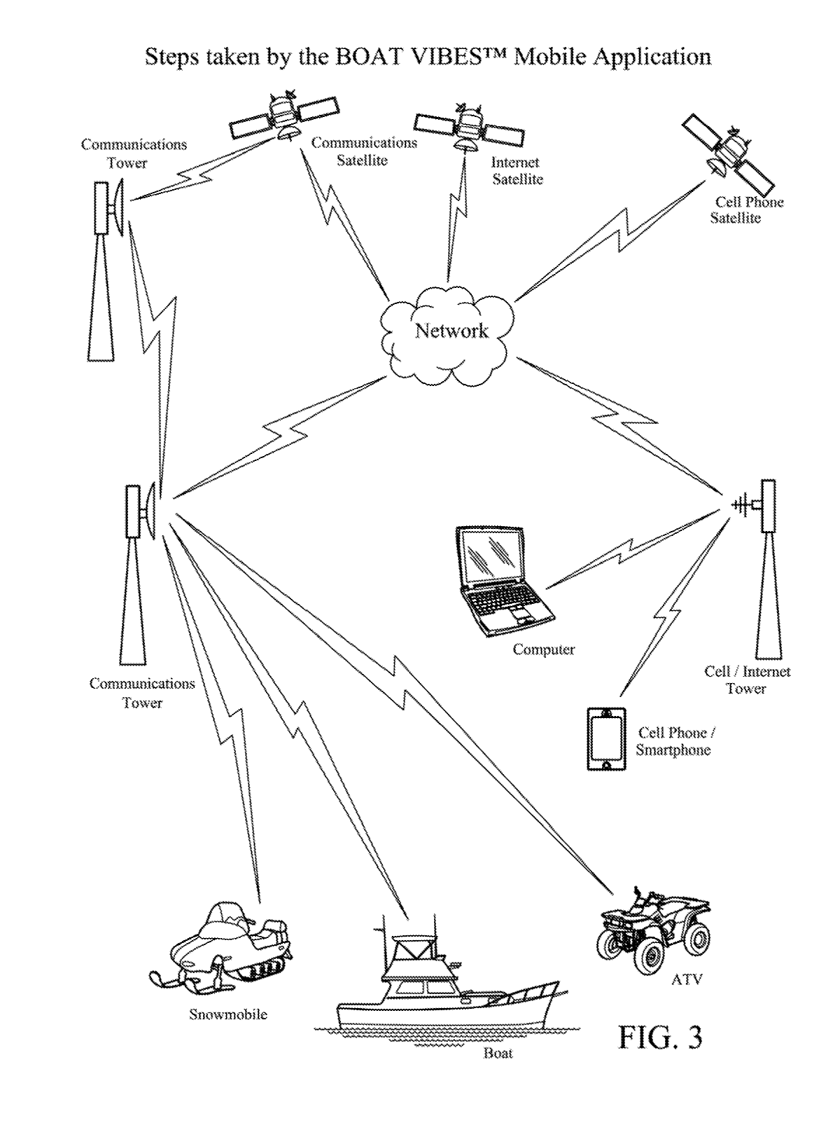

FIG. 3 depicts a diagram of the BOAT VIBES™ mobile application. The BOAT VIBES™ tri-system mobile application is in direct communication with a smartphone, cell phone and/or computer through the existing network of communications satellites, Internet-based satellites. Cell Phone based satellites, communications towers and Cell/Internet Towers, regardless of whether the user is engaging in outdoor sports related to boating, off-roading with an ATV, a motorcycle, or snowmobiling.

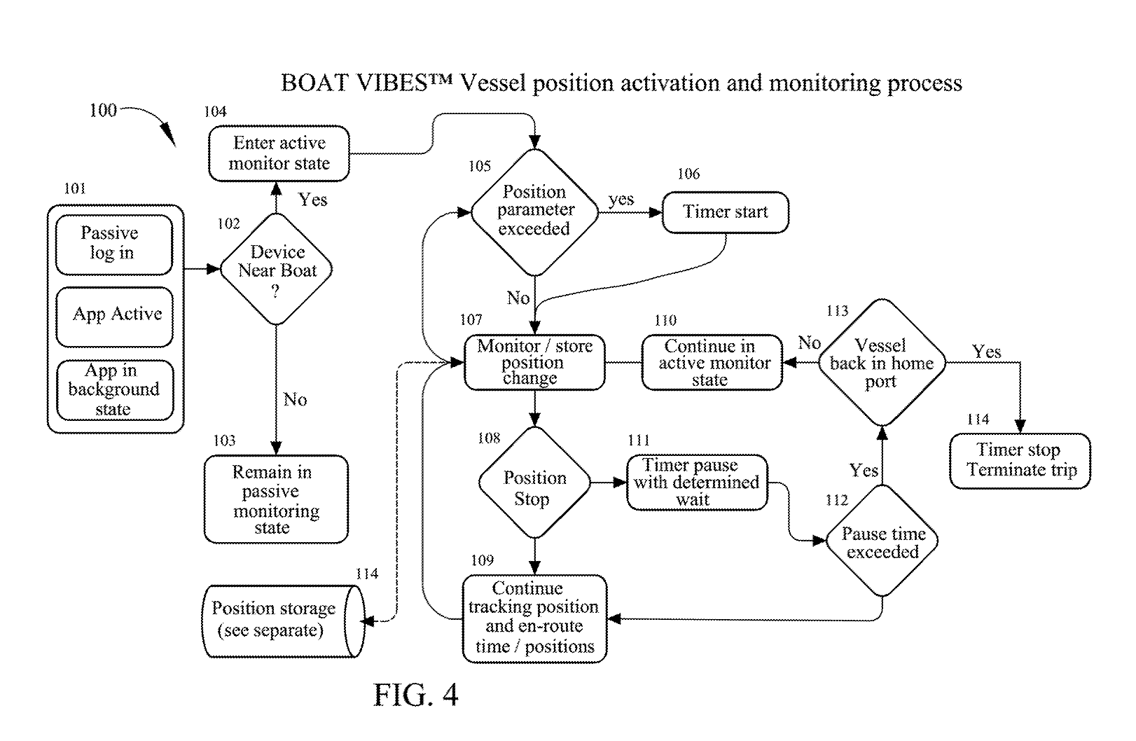

FIG. 4 depicts a diagram of the vessel position activation and monitoring process 100 where application runs in background whether or not if has a valid session with BOAT VIBES™. It awaits proximity to boats position in marina or vessel home position. Referring now to FIG. 4, the following application steps are outlined below:

Mobile device is within a defined proximity to validated/not validated marina and/or slip position, including introduced GPS fault 101.

Near boat, application watches for position change reflecting movement over water 102.

Does position change? If so, what action to take 104.

No change continue to monitor for changes exceeding set values 103.

Stilt within range of boat? If not disable monitor 105.

Vessel moves outside of the GPS fault introduced range in a manner consistent with linear movement over water 107.

Actively monitor position changes 106.

Has vessel stopped movement 108.

NO—Continue to monitor and record changes 110.

Yes—Timer pauses with determined wait time, (is this overnight or long term stop away from home port) 111.

If pause timer is exceeded what is the current vessel placement 112.

Vessel is not in home port so continue on trip meter pausing trip 109.

Is vessel in home port 114.

Continue trip meter, vessel is far enough outside home port to continue recording.

Vessel is in home port and movement has discontinued for a period determined by application to validate trip end. End trip timer on no position change within home port.

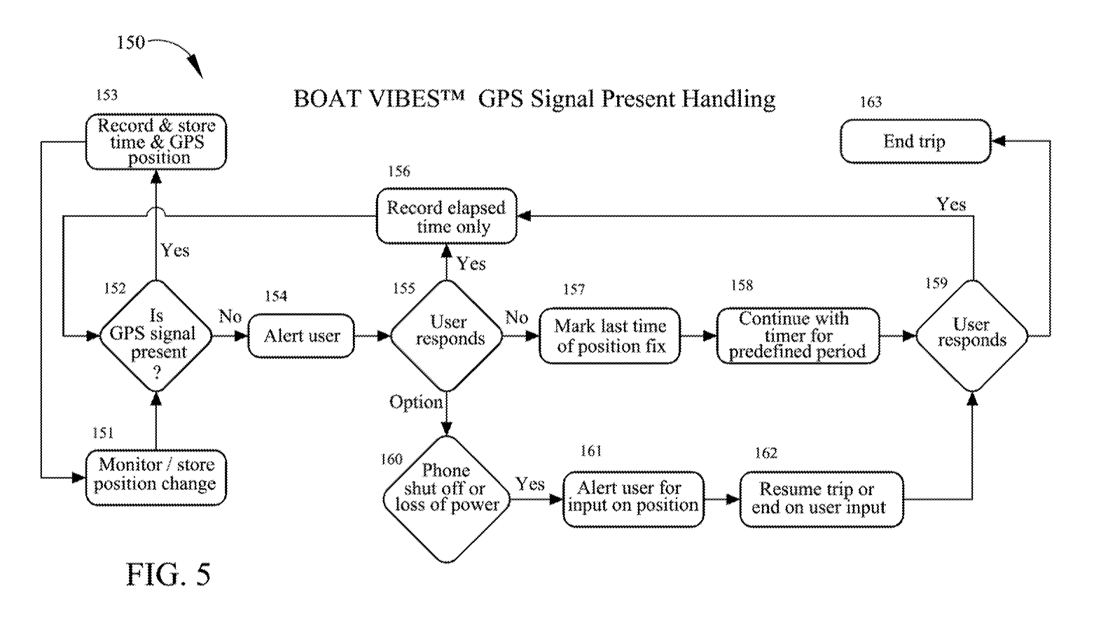

FIG. 5 depicts a diagram of the GPS signal present handling 150. Referring now to FIG. 5, the following application steps are outlined below:

Is there a GPS signal present 152.

With presence of GPS signal record coordinates with time stamp 153.

Upon persistence, of GPS signal loss and using a stored timer alert. Alert for user action 154.

Does User respond 155.

If user responds that trip is still in motion record lapse time only until return of signal 156.

Flag last fixed geo-position as option to stop trip timer at later time 157.

Continue with trip timer for programmatically set time interval before ending trip 158.

Does user respond to alert within set time 159.

OPTION: if phone losses power or is shut off 160.

OPTION: alert user upon power up 161.

OPTION: wait for user response to end trip or continue 162.

Find trip 163. The BOAT VIBES™ App is programmed to input data on engine usage hours in the circumstance where a GPS signal is not being received tor any reason. If a GPS signal is not being received in the vessel/vehicle's current or starting location because the user's phone wasn't turned on or it lost power or if no GPS signal is present 152, the Boat Vibes App user is prompted to this status on his/her App screen 154. The user can then manage the hour tinier manually. If the App user does not respond to the screen alert of no GPS signal present, the Boat Vibes App will automatically mark the engine hours' time when his last GPS fix was made 157 and use this as the starting time to start the hours timer until the end of the current trip or for a default elapsed time that the user will select 158, at which point the elapsed time only is recorded and stored 159. Alternatively, if the user had his phone off or the phone lost power 160, upon being alerted 161, he can input his position and resume the trip using his own input 162 or he can end the trip™. The engine hour's usage record is maintained with minimal loss of accuracy.

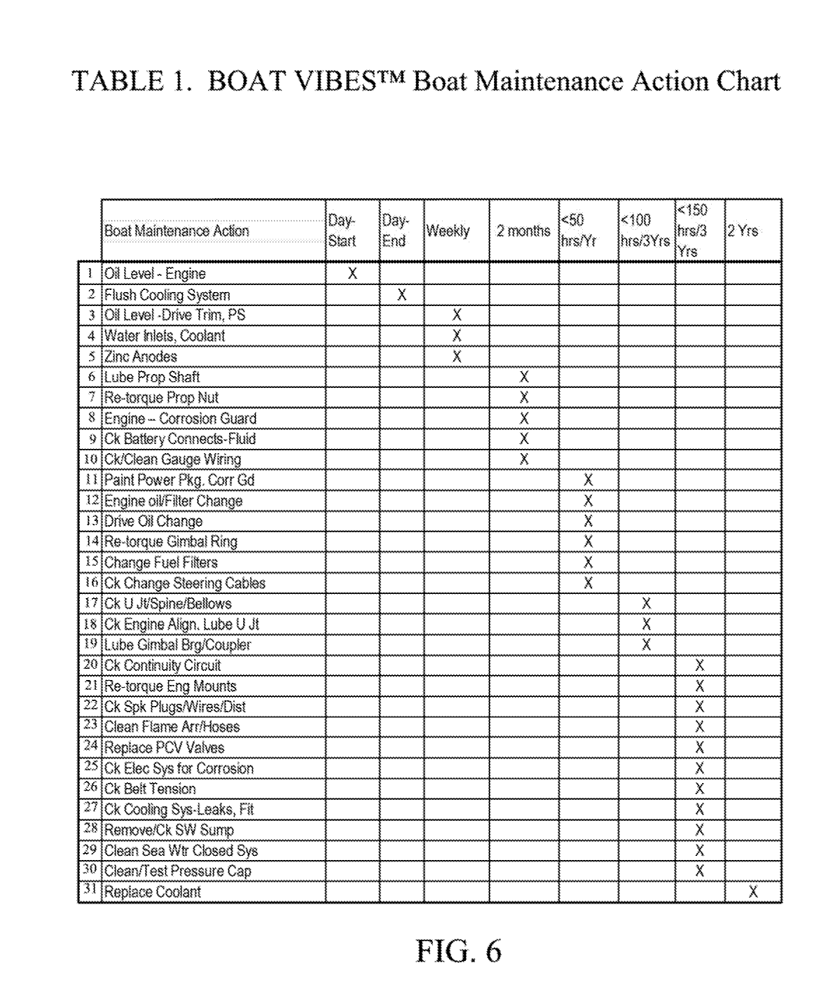

FIG. 6 illustrates TABLE 1, which is a tabular example of a BOAT VIBES™ boat maintenance action chart. It shows the service intervals for many of the service actions required to maintain a solid reliable working outboard or other marine vessel engine.

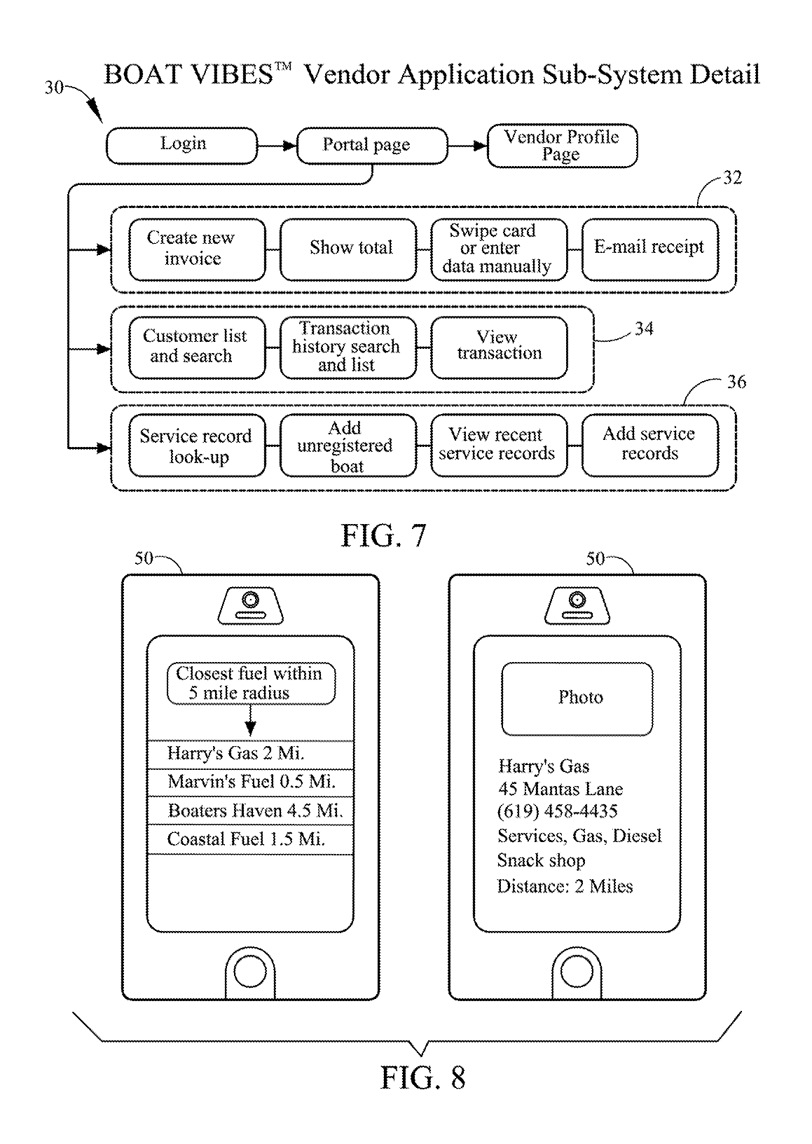

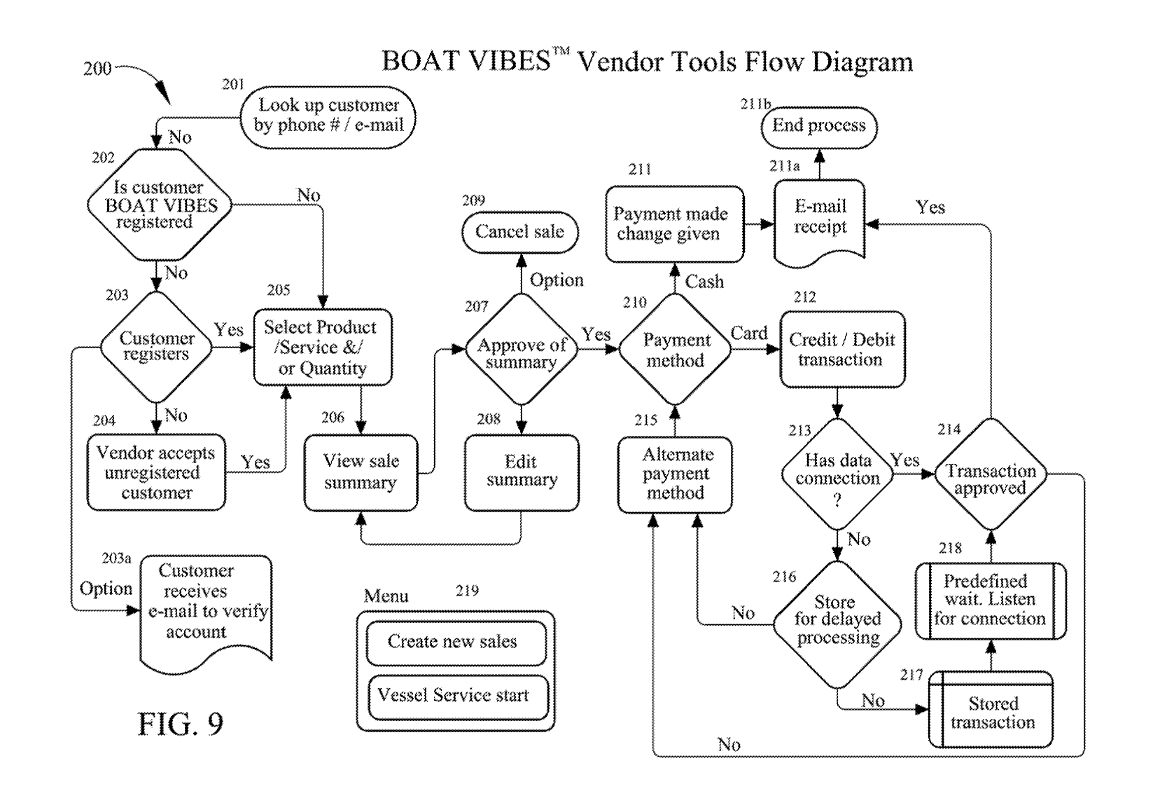

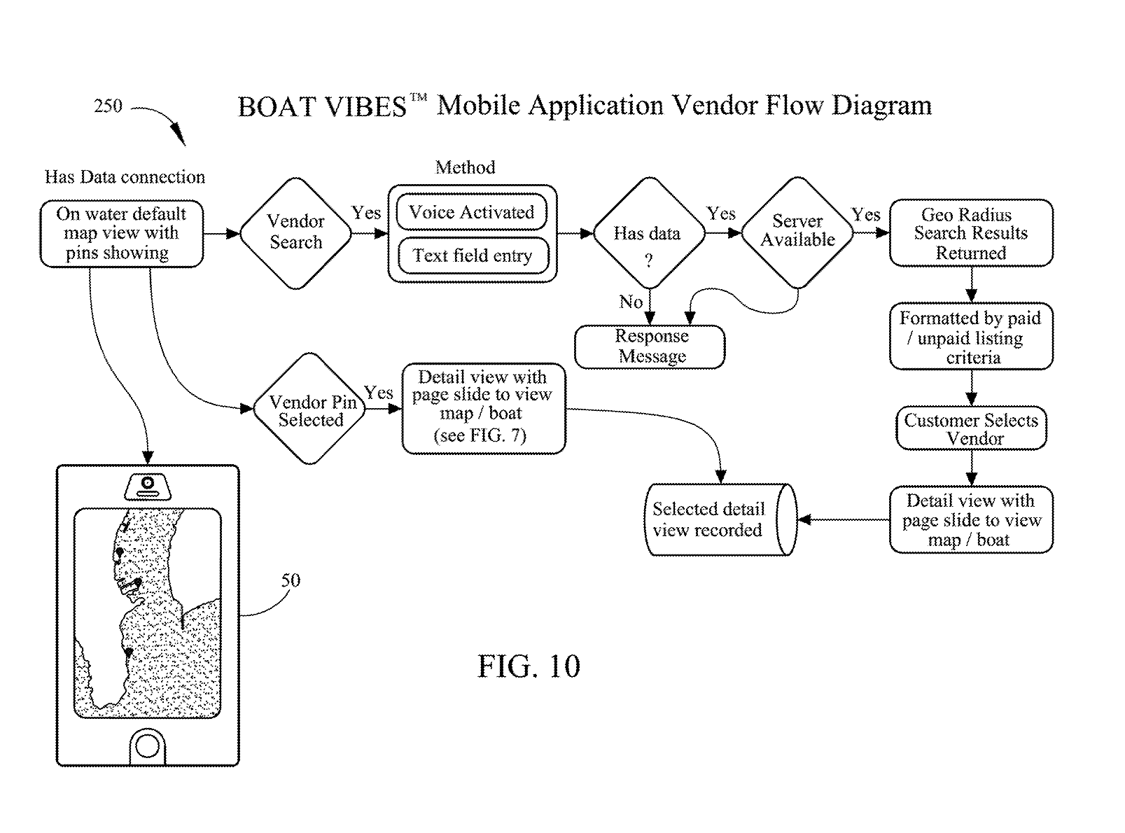

FIG. 7 depicts a diagram of the BOAT VIBES™ vendor application sub-system detail 30 showing three separate service vendor flows, namely, a create a new service invoice flow 32, a customer list and search flow 34, and a sendee record look-up flow 36, where service records can be viewed remotely from any location connected to the network (see FIG. 3).

FIG. 8 depicts an illustration of the use of the mobile app on two smartphones 50. The smartphone on the left has a button Closest fuel within 5 mile radius, which has been pushed by the user to produce the smartphone 50 on the right. The smartphone 50 on the left has a listing of the closest fuel within a 5 mile radius. This list is not arranged based upon distance, but rather it is based upon having a vendor pay extra to BOAT VIBES™ to be listed on top or closer to the top regardless of the actual distance away from the user. As is shown, when the tab Harry's Gas is pushed the smartphone 50 screen on the right is generated. This newly generated screen shows a photo of Harry Gas, gives the address and telephone contact number, as well as a small list of available services at that location, and finally the actual distance away from the user.

FIG. 9 depicts a diagram of the BOAT VIBES™ vendor tools flow 200, where vendor chooses to create a new sale or vessel service entry by looking up customer by phone number or email address in search field 201. Referring now to FIG. 9, the following application steps are outlined below:

Is the customer a registered boat vibes member 202.

Customer chooses whether or not to register 203.

If customer registers they will receive an email to confirm account 203a.

Customer does not register and a name is added to the receipt or name is read from credit card if available 204.

On invoice entry page products/services are selected along with a quantity and a preprogrammed price if available 205.

Summary of sale is shown with a product/service list, subtotal and total cost to be charged 206.

Customer or vendor approves of list and amount to be charged 207.

Summary needs to be modified and changes are made 208.

Sale is canceled 209.

Payment method cash is chosen 210.

If applicable signature and approve button is used to validate charge by customer. Receipt is e-mailed to customer if address is on file or given at start of sale 211a.

Process ended 211b.

Credit/Debit transaction chosen 212.

Does device have data connection 213.

Device has data connection, card is-processed and approved. In the instance the transaction is not approved vendor is prompted with appropriate message and another payment method can be chosen 214.

Alternate payment chosen 215.

Proceed with a stored transaction for later processing or reject transaction and request alternate payment method 216.

Choice is made to store transaction for future processing 217.

Application will look for data connection at pre-programmed intervals to send data and inform vendor of result upon completion 218. FIG. 9 describes the BOAT VIBES™ App from the Vendor's point of view. The App makes it easy to process transactions for both registered and non-registered BOAT VIBES™ users 202, while recording the user's service and payment data and storing it for the Vendor's and the user's future use and reference. Once the customer's data and service request is input by the vendor 207, the customer can review the transaction and approve the final version 207, and a sales payment method is then selected and processed. Multiple options of payment are available to the vendor and customer. Including cash 211, credit card both on an immediate basis if a card processing connection is available 214, or a delayed basis if a connection isn't available. In the latter case, the transaction data is stored and a connection is available 217. In all cases, the vendor increases his sales reach from just one physical location to thousands of locations in the form of BOAT VIBES™ users. The App reaches walk-in customers, customers on the water and referred customers and locks in the service, the payment and the record keeping. The customer's service records stay up to date and accessible to the vendor, and the BOAT VIBES™ user if they are already registered or want to register, for the next service. The customer receives email receipts for Card transactions 211a. BOAT VIBES™ provides the vendor with all of the tools to exponentially expand his/her business model.

FIG. 10 depicts a diagram of the BOAT VIBES™ visual flow 250. Referring now to FIG. 10, the following application steps are outlined below:

NOTE: the mobile application needs data connection to do search by geo-position and to do extended searches for data not stored on phone memory.

On water default . . . —When in on water state, map view is the default view. Here, the map view is shown displayed on a smartphone screen 50. This smartphone 50 screen displays a map with pins locating nearest fuel, or food, or other services, etc.

Vendor Search—Tapping on the search button enables either voice or text input as indicated by “method” box.

Has Data—?? Search result returned.

Server Avail—is the server available for response?

Response Message—Application returns appropriate message.

Geo-radius search—Server by default returns a list view of appropriate services based upon geo position obtained from the mobile device.

Formatted by paid—List views will be sorted by selected tier priority.

Customer selects vendor—Front list view customer selects a vendor.

Detail view . . . —Detail view of vendor information.

Selected detail view . . . —The selected vendor is recorded on central database.

Vendor Pin Selected—Vendors are represented by pins on a map

Detail View . . . —When a boater selects a pin the selection is recorded on central server and a detail view is displayed. A major feature of the BOAT VIBES™ App is to effortlessly summon information on desired services in a specific geographic location, either one that you are currently or at some future destination. When a BOAT VIBES™ App user is on the water and has a data connection, he or she can summon vendor service by specific category by voice or by text using his app. He can also use a map with pins showing the vendors in proximity to his location. Vendors will then be displayed in accordance with their paid listing criteria and the vendor selected will have their business profile details appear on a separate screen and the user can make his arrangements for service.

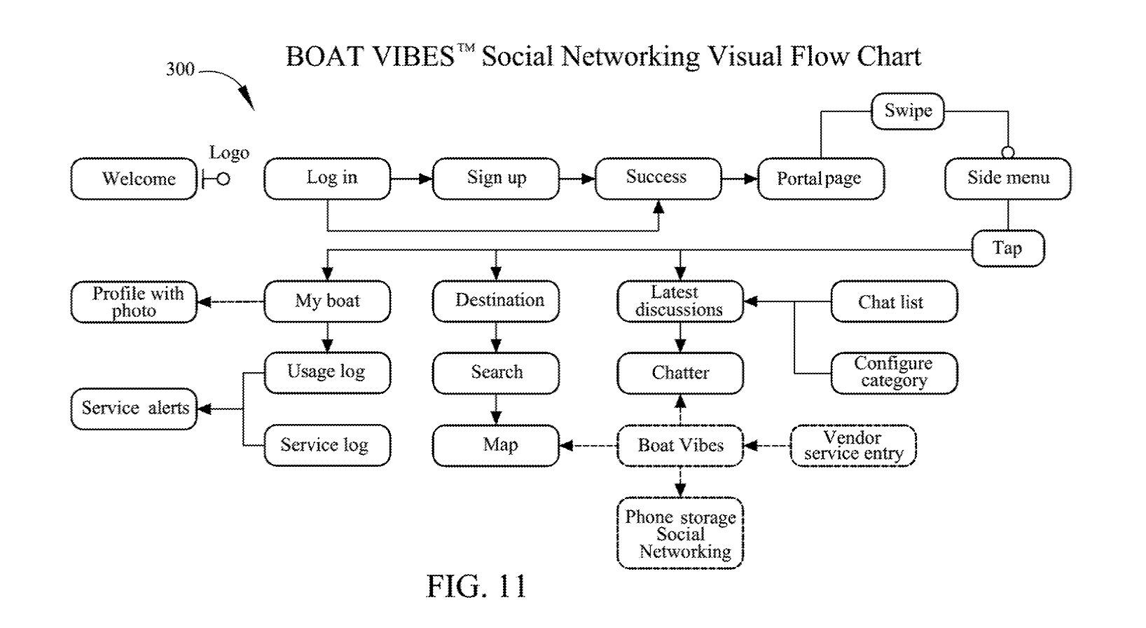

FIG. 11 depicts a diagram of the BOAT VIBES™ social media/networking visual flow 300. Referring now to FIG. 11, the following application steps are outlined below:

Welcome—Splash page with large logo, used while app is loading in background.

Login—Site login prompt [user name, password].

Sign-up—Sign up.

Success—Feedback message to logged in user.

Portal page—Application entry point.

Swipe—Screen finger gesture to access side menu.

Side menu—Side menu showing features available on application.

Profile with Photo—Mobile—abbreviated information on list style that can be updated by boat owner. Web site—Full boat data that can be edited when needed. Some information will be locked to prevent cheating.

My-Boat—[Menu item] linking to usage log, service log and profile.

Destinations—[Menu item] with “latest” list of blog entries in geographic area with ability to search on zip code, city or current geo location. Swipe gesture switches between list view and map view.

Latest Discussion—[Menu item] list view of latest blog style discussions.

Chat list—list of most recent discussions boater has participated in.

Configure categories—setting—select from check list of available topics interested in.

Usage Log—List view of usage events.

Search—Already defined in “destinations”.

Chatter—A product name for discussions and should be on the top of view where “latest discussions” is.

Service alerts—Can be accessed via my boat on sub navigation. Mostly comes up when interval timer is reached.

Service log—Log of services performed and registered by owner and BOAT VIBES™ registered providers. Will not have detail view only high level view.

Map—Map can be accessed after a search is performed.

BOAT VIBES™

Vendor Service entry—Allows vendors to enter service flow.

Phone storage—Some data with specific business rules defined by usage will be stored on phone to speed access and provide information when in offline mode. Another major-feature of the BOAT VIBES™ App is the ability of the user network to share their experiences while on the water. They can at a location or in route to one and have recommendations and invitations to offer to Mends and fellow travelers. Boating activities can be planned or spontaneous in nature and being able to ask for advice from other boaters or vendors can make any outing more satisfying as you learn what is actually happening all around you. Other BOAT VIBES™ App users can learn reach out to another user and learn a little bit more about common interests and activities in boating.

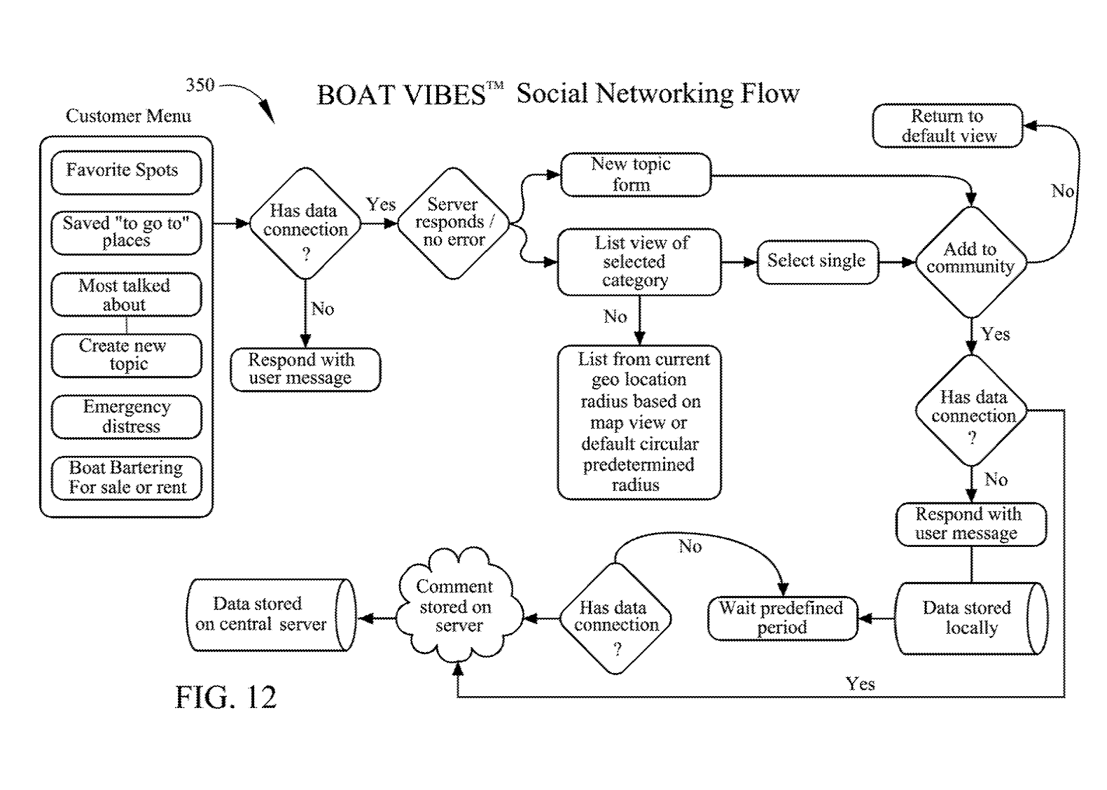

FIG. 12 depicts a diagram of the BOAT VIBES™ social networking flow 358. Referring now to FIG. 12, the following application steps are outlined below:

Customer Sub Menu—Main menu items for social media. The various menu items may include: Favorite Spots, Saved “to go to” places, most talked about, create new topic, emergency/distress. Boat Bartering For sale trade or rent selections.

Has data connection—indicates mobile device has active data connection.

Respond with user message—Visual response message indicating state.

Server responds when no error. Positive server state.

New topic form—Add a new topic from form.

List view of selected categories—select from list of topics.

Select single—select discussion topic (should probably connect to “read discussion”)

Acid to community—Add topic to community.

Return to default view—Return to most recent selected sub item.

Has data connection—has cellular data connection.

Respond with user message—Give user feedback with appropriate message.

Data stored locally—save locally in an offline mode to be uploaded upon positive data connection.

Wait predefined period—sleep for X seconds before trying to upload data.

Has Data connection—Has cellular data connection.

Comment stored on server—Comment/Topic is uploaded to central server and available to whole community via internet.

Data stored on central server. The lively interchange by BOAT VIBES™ users of thoughts and ideas about their boats and boating adventures is accomplished in the Social Networking feature. From a menu, the App user can select topics ranging from the latest events and currently trending themes to creating a new topic and encouraging comments. The feature also lists emergency distress contact information. In addition, BOAT VIBES™ also offers users a paid listing sendee called Boat Barter, where users can list their vessels for sate, rent or trade, or they can express an interest in a specific type of new or used boat they are thinking of buying. All data is stored for future use.

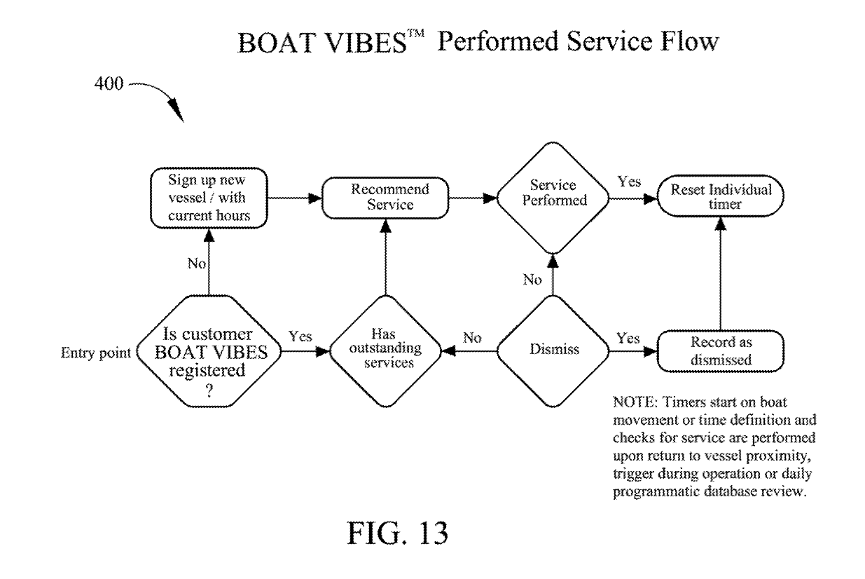

FIG. 13 depicts a diagram of the BOAT VIBES™ performed service flow 400. This illustrates a Vendor App, Log-in, and Invoicing Process Map. This FIG. 13 is an enhancement or overview of the process shown in FIG. 7, the BOAT VIBES™ Vendor Application Sub-system Detail (see FIG. 7). It shows the vendor's perspective of Boat Vibes when logging into his or her tablet or desktop. FIG. 8 then details the transaction as it takes place on a smartphone 50 display (see FIG. 8).

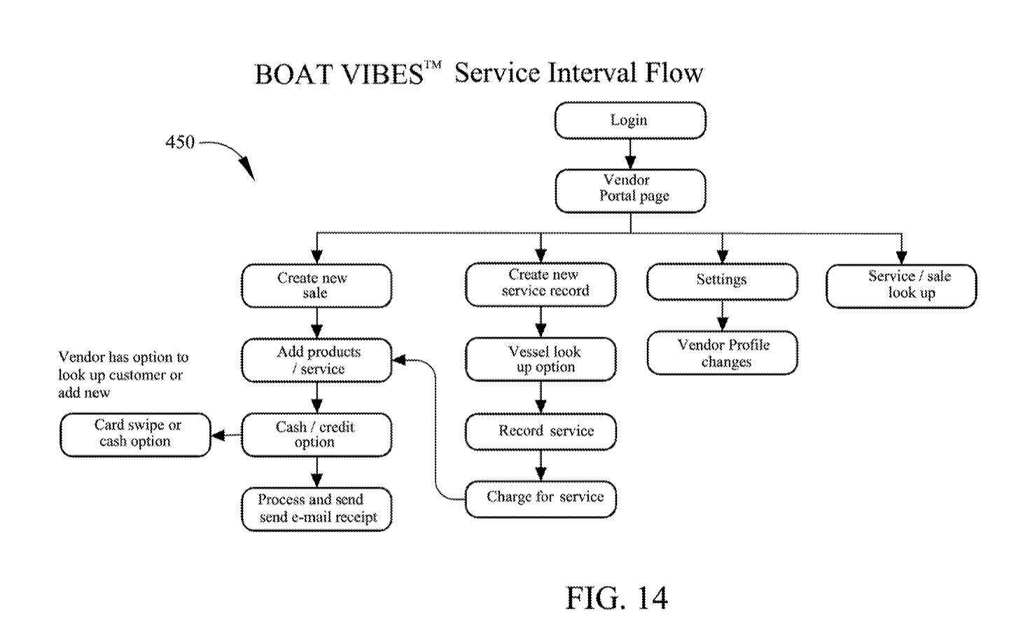

FIG. 14 depicts a diagram of the BOAT VIBES™ service interval flow 450. The Service Internal Mechanism flow chart is simply the description of what happens at the beginning of the vendor and/or user commencement of service and at every service prompt cycle thereafter. Both BOAT VIBES™ subscribers and vendors have the opportunity to add new subscribers and vendors during the initial log-in.

In summary, the BOAT VIBES™ tri-system mobile smartphone application for use during outdoor motor sports activities, enables all of the following:
Boat Vibes Mobile App (“BV”) provides GPS location based motion detection that records movement over water or land (as chosen in settings) and converts it to hours and minutes of motor usage. This usage appears on the app's service tile on the app portal as a periodically updated digital number on an Hour Meter dial.
When manufacturers' recommended maintenance milestones are reached for numerous specific individual service tasks, the user is notified on the app's service tile on the app portal via the appearance of a notification dial showing which service is suggested by manufacturers. The engine manufacturer's name will be listed on lower half of the notification dial and tapping the dial will bring up the closest manufacturer's authorized dealer. They can dismiss the notification, in which case they will be notified again at that next recommended interval and their service record will show that they dismissed the first notification.
On the BV app's Concierge tile, users can select other services and goods providers from a series of service and vendor categories and these will be listed based on GPS location and user distance preference.
BV vendors can create invoices for BV users and those service maintenance histories and invoices will be stored on BV's cloud for retrieval by BV users anytime and anywhere around the globe. This eliminates the need for paper files that may become lost and eliminates user dependence on vendor record storage.
Payments can be processed using the app and a registered BV vendor.
The BV app can be activated by voice or typing.
The BV app can be updated for both vendors and users by using the conventional BV website.
Boat Vibing is the name of the social component of the BV app. It allows users to communicate with each other as a community, sharing recommendations, events and tips among each other and facilitating assistance and meet-ups.
BV users can place classified advertising on the app and reach the specific targeted community of boaters with their offerings.

The Boat Vibes app features a status alert system for the user. In the event where the wireless device loses signal or power, the user is prompted to this status by a screen alert. The user can then either manage the hour timer manually by inputting his position on the app and resuming the trip, or end the trip. Minimal loss of accuracy is achieved. If the user does not respond to the alert of no GPS signal being present, the BV app will automatically mark the hour meter run time from the last GPS waypoint and use this as the starting position until the end of the current trip. The BV app user can also use a selected default elapsed time to approximate run hours between GPS coverage and this time will be recorded.
The BV user can pause the hour meter if only accessories are running on the boat. This feature could be used when the boat hour meter recording would normally be functioning, having been automatically started when the vessel is outside of the home port default range GPS location and moving at greater than the default drift motion speed of at least 2.5 miles per hour.
BV app users can process payments using Stripe accounts with the vendors. Customer and vendor agree to payment information or modify it as necessary and receipts are emailed to the user. If a wireless connection isn't available, the data is stored until one becomes available.
On BV's registration website, some data will be locked to prevent manipulation of records. When selling or insuring a vessel, the availability of these tamper proof records will be of great value to all parties to the transaction.
BV users can recommend vendors that they use to the vendor list and request that the vendor register as a BV vendor to enjoy the benefits of the system.
In the Boat Vibing social interaction component, users can alert other users to information about thefts, accidents or other emergencies and request other users within the GPS position to provide immediate information or assistance.
In the event of theft of a boat or engine, the BV app boater's profile has the boat name, year, serial number, make, model, length, weight, beam, draft, fuel capacity, current run hours, engine manufacturer, engine number and horsepower to immediately be provided to insurance providers, the Coast Guard and other law enforcement entities.
The BV app's Boat Vibing component has multiple categories for general classified and employment ads, renting, buying and selling of vessels, blogging, recommendations and favorite photo postings.
BV app users can list favorite places, things, events, and activities on their user profile, in the “Favorites” tab, to retrieve and refresh their memories when they go boating
BV users can save favorite articles about their interests on their user profile under a separately labelled tab.
The BV app can be used in conjunction with monitoring boats and other vessels, snowmobiles, ATV's, motorcycles and other off-road recreational vehicles.
The BV app has a Google map feature which allows the user to see his GPS position and has pins of vendors locations accessed from the Concierge list.

The Tri-system Mobile App 10 shown in the drawings and described in detail herein disclose arrangements of elements of particular configuration for illustrating preferred embodiments of method of operation of the present application. It is to be understood, however, that elements of different configuration and other arrangements thereof, other than those illustrated and described may be employed for providing a Tri-system Mobile App 10 in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. A tri-system mobile smartphone application for use during outdoor motor sports activities, comprising:
a) a global positioning satellite (GPS) based sub-system which senses geo-physical movement and thereby measures motor running time, motor usage and monitors both for the purpose of both calculating motor running time and alerting the user of maintenance actions when maintenance actions are due based on motor running time calculations;
b) a vendor/marketing sub-system for the purpose of marketing a plurality of goods and services, geo-physically locating vendors providing a plurality of goods and services within adjustable distance parameters, and providing user reviews of marketed goods and services and vendors providing goods and services; and
c) a social media/social networking sub-system for the purpose of detecting, geo-physically locating and communicating with others thereby facilitating social interaction, goods and services classified ad services and emergency situations through communications with others, while engaging in outdoor motor sports.

2. The tri-system mobile smartphone application for use during outdoor motor sports activities according to claim 1, wherein said global positioning satellite (GPS) based sub-system monitors motor time usage in hours run time based on GPS coordinates movement data when the motor vessel or vehicle is under way over water or land.

3. The tri-system mobile smartphone application for use during outdoor motor sports activities according to claim 1, wherein said global positioning satellite (GPS) based sub-system notifies the user when motor maintenance events are due based on number of hours of running time for the motor.

4. The tri-system mobile smartphone application for use during outdoor motor sports activities according to claim 1, wherein said vendor/marketing sub-system uses a GPS location system to notify the user of closest services in the location vicinity, and displays to the user the closest services and more distant vendors of goods and services within user specified distances.

5. The tri-system mobile smartphone application for use during outdoor motor sports activities according to claim 1, wherein said vendor/marketing sub-system provides contact information, photos and customer reviews for vendors of goods and services detected and displayed.

6. The tri-system mobile smartphone application for use during outdoor motor sports activities according to claim 1, wherein said social media/social networking sub-system alerts and detects other vessels and vehicles in the vicinity of the user within a user specified distance.

7. The tri-system mobile smartphone-application for use during outdoor motor sports activities according to claim 1, wherein said social media/social networking sub-system allows for communications contact between the user and other detected vessels/vehicles, including vessel/vehicle negotiating for purchase/sale/rental terms.

8. The tri-system mobile smartphone application for use during outdoor motor sports activities according to claim 1, wherein said tri-system mobile smartphone application communicates wirelessly with a vessel/vehicle user through a global computer network using cell phones, smartphones, computers, communications satellites, Internet satellites, cell phone system satellites and land based communications towers.

9. The tri-system mobile smartphone application for use during outdoor motor sports activities according to claim 1, wherein said vendor/marketing sub-system for the purpose of marketing a plurality of goods and services, geo-physically locating vendors providing a plurality of goods and services within adjustable distance parameters, and providing user reviews of marketed goods and services and vendors providing goods and services, further includes a map view display with indicators of geographical locations of vendors of goods and services on said map view display.

10. The tri-system mobile smartphone application for use during outdoor motor sports activities according to claim 1, wherein said global positioning satellite (GPS) based sub-system which senses geo-physical movement and thereby measures motor running time, motor usage and monitors both for the purpose of both calculating motor running time and alerting the user of maintenance actions when maintenance actions are due based on motor running time calculations, further includes tracking service interval flow and performed service flow for the user's vessel/vehicle motor being monitored.

11. A method for making a tri-system mobile smartphone application for use during outdoor motor sports activities, comprising the steps of:
a) providing a global positioning satellite (GPS) based sub-system which senses geo-physical movement and thereby measures motor running time, motor usage and monitors both for the purpose of both calculating motor running time and alerting the user of maintenance actions when maintenance actions are due based on motor running time calculations;
b) providing a vendor/marketing sub-system for the purpose of marketing a plurality of goods and services, geo-physically locating vendors providing a plurality of goods and services within adjustable distance parameters, and providing user reviews of marketed goods and services and vendors providing goods and services; and
c) providing a social media/social networking sub-system for the-purpose of detecting, geo-physically locating and communicating with others thereby facilitating social interaction, goods and services classified ad services and emergency situations through communications with others, while engaging in outdoor motor sports.

12. The method for making a tri-system mobile smartphone application for use during outdoor motor sports activities according to claim 11, wherein said global positioning satellite (GPS) based sub-system monitors motor time usage in hours run time based on GPS coordinates movement data when the motor vessel or vehicle is under way over water or land.

13. The method for making a tri-system mobile smartphone application, for use during outdoor motor sports activities according to claim 11, wherein said global positioning satellite (GPS) based sub-system notifies the user when motor maintenance events are due based on number of hours of running time for the motor.

14. The method for making a tri-system mobile smartphone application for use during outdoor motor sports activities according to claim 11, wherein said vendor/marketing sub-system uses a GPS location system to notify the user of closest services in the location vicinity, and displays to the user the closest services and more distant vendors of goods and services within user specified distances.

15. The method for making a tri-system mobile smartphone application for use during outdoor motor sports activities according to claim 11, wherein said vendor/marketing sub-system provides contact information, photos and customer reviews for vendors of goods and services detected and displayed.

16. The method for making a tri-system mobile smartphone application for use during outdoor motor sports activities according to claim 11, wherein said social media/social networking sob-system alerts and detects other vessels/vehicles in the vicinity of the user within a user specified distance.

17. The method for making a tri-system mobile smartphone application for use daring outdoor motor sports activities according to claim 11, wherein said social media/social networking sub-system allows for communications contact between the user and other detected vessels/vehicles, including vessel/vehicle negotiating for purchase/sale/rental terms.

18. The method for making a tri-system mobile smartphone application for use during outdoor motor sports activities according to claim 11, wherein said tri-system mobile smartphone application communicates wirelessly with a vessel vehicle user through a global computer network using smart cell phone technology, smartphones, computers, communications satellites, Internet satellites, cell phone system satellites and land based communications towers.

19. The method for making a tri-system mobile smartphone application for use during outdoor motor sports activities according to claim 11, wherein said vendor/marketing sub-system for the purpose of marketing a plurality of goods and services, geo-physically locating vendors providing a plurality of goods and services within adjustable distance parameters, and providing user reviews of marketed goods and services and vendors providing goods and services, further includes a map view display with indicators of geographical locations of vendors of goods and services on said map view display.

20. The method for making a tri-system mobile smartphone application for use during outdoor motor sports activities according to claim 11, wherein said global positioning satellite (GPS) based sub-system which senses geo-physical movement and thereby measures motor running time, motor usage and monitors both for the purpose of both calculating motor running time and alerting the user of maintenance actions when maintenance actions are due based on motor running time calculations, further includes tracking service interval flow and performed service flow for the user's vessel/vehicle motor being monitored.
